(19) United States
(12) Patent Application Publication
(10) Pub. No.: US 2012/0318880 A1
(43) Pub. Date: Dec. 20, 2012

(54) VEHICLE AIR-CONDITIONING SYSTEM

(75) Inventors: Hideki Hashigaya, Hamamatsu-shi (JP); Isamu Ito, Hamamatsu-shi (JP); Yorisada Kondo, Hamamatsu-shi (JP); Yuki Futuhara, Hamamatsu-shi (JP)

(73) Assignee: SUZUKI MOTOR CORPORATION, Shizuoka (JP)

(21) Appl. No.: 13/493,565

(22) Filed: Jun. 11, 2012

(30) Foreign Application Priority Data
Jun. 15, 2011 (JP) 2011-132889

(51) Int. Cl. G05D 23/00

(52) U.S. Cl. 236/94

(57) ABSTRACT

A fault diagnosis unit 61 identifies that a system is out of order and stops driving of a heater 51 (step S8) when a preset first setting time elapses after a start of driving of an electric-powered water pump 42 and a heater 51 (step S3 and step S4), a value obtained by subtracting temperature detected by a heater inlet temperature sensor 52 from temperature detected by a heater outlet temperature sensor 53 is less than or equal to a preset first threshold (step S5), and a value obtained by subtracting temperature detected by a water temperature sensor 43 before a start of driving of the electric-powered water pump 42 and the heater 51 from temperature detected by the water temperature sensor 43 is less than or equal to a second threshold (step S6).

### FIELD OF THE INVENTION

The present invention relates to an air-conditioning system for a vehicle suitable for an electric vehicle and a hybrid vehicle, etc.

### RELATED ART

In some electric vehicles and hybrid vehicles, there is one which is equipped with a heater such as a Positive Temperature Coefficient (PTC) heater, etc. for heating cooling water, installed on a cooling water cycling loop on which a heater core and an electric water pump are arranged.

In Patent Document 1, there is disclosed identifying a system (e.g., an electric-powered water pump) failure, under such an arrangement, based on a temperature difference between temperature of a heater core and temperature detected by a water temperature sensor for detecting temperature of cooling water in the cooling water cycling loop.

### PRIOR ART DOCUMENT

Patent Document 1: JP 2005-343412 A

### SUMMARY OF THE INVENTION

### Problem to be Solved

In the above identification scheme based on the temperature difference between the temperature of the heater core and the temperature detected by the water temperature sensor, however, there are circumstances, in some cases, where misidentification might be committed, depending on heat exchange rates by the heater core.

For example, the heat exchange rates of the heater core are more susceptible to be changed due to air quantity to be hit against the heater core, and temperature at a blower outlet, etc. At this time, in the event that the heat exchange rates of the heater core are little (i.e., heat loss of the heater core is little), the temperature of the heater core and the temperature detected by the water temperature sensor rise while maintaining same difference value between the temperature of the hear core and the temperature detected by the water temperature sensor, which avoids an increase in the temperature difference. Hence, it is likely to commit misidentification that the electric water pump etc. is out of order.

An objective of the present invention is to conduct identification of a system error with high accuracy using temperature detected by a sensor, even when heat exchange rates of the heart core vary.

### Solution to the Problem

To solve the above-identified problems, according to one embodiment of the present invention, the invention may provide a vehicle air-conditioning system including a heat exchanger to heat ventilating air by heat-exchanging the ventilating air to an interior of a vehicle and a heat medium, a heater to heat the heat medium, and a pump to circulate the heat medium within a cycling loop to which the heat exchanger and the heater are connected, the system comprising: a first temperature detector for detecting temperature of the heat medium flowed in the heater; a second temperature detector for detecting temperature of the heat medium flowed out from the heater; a third temperature detector installed in the cycling loop for detecting temperature of the heat medium in the cycling loop; and a fault identifying unit for identifying that the system is out of order when a preset first setting time elapses after a start of driving of the heater and the pump, a value obtained by subtracting temperature detected by the first temperature detector from temperature detected by the second temperature detector is less than or equal to a preset first threshold, and a value obtained by subtracting temperature detected by the third temperature detector before the start of the driving of the heater and the pump from temperature detected by the third temperature detector is less than or equal to a preset second threshold.

Further, in one aspect of the present invention, the fault identifying unit may identify that the system is out of order, in a case where a state satisfying conditions continues for a preset second setting time, the conditions being that the preset first setting time elapsed after the start of the driving of the heater and the pump, the value obtained by subtracting temperature detected by the first temperature detector from temperature detected by the second temperature detector is less than or equal to the preset first threshold, and the value obtained by subtracting temperature detected by the third temperature detector before the start of the driving of the heater and the pump from temperature detected by the third temperature detector is less than or equal to the preset second threshold.

According to one aspect of the present invention, the embodiment may provide a vehicle air-conditioning system including a heat exchanger to heat ventilating air by heat-exchanging the ventilating air to an interior of a vehicle and a heat medium, a heater to heat the heat medium, and a pump to circulate the heat medium within a cycling loop to which the heat exchanger and the heater are connected, the system comprising: a first temperature detector for detecting temperature of the heat medium flowed in the heater; a second temperature detector for detecting temperature of the heat medium flowed out from the heater; and a fault identifying unit for identifying that the system is out of order when a preset first setting time elapses after a start of driving of the heater and the pump, a value obtained by subtracting temperature detected by the first temperature detector from temperature detected by the second temperature detector is less than or equal to a preset first threshold, and a value obtained by subtracting temperature detected by the first temperature detector before the start of the driving of the heater and the pump from temperature detected by the first temperature detector is less than or equal to a preset second threshold.

According to one aspect of the present invention, the fault identifying unit may identify that the system is out of order, in a case where a state satisfying conditions continues for a preset second setting time, the conditions being that the preset first setting time elapsed after the start of the driving of the heater and the pump, the value obtained by subtracting temperature detected by the first temperature detector from temperature detected by the second temperature detector is less than or equal to the preset first threshold, and the value obtained by subtracting temperature detected by the first temperature detector before the start of the driving of the heater and the pump from temperature detected by the first temperature detector is less than or equal to the preset second threshold.

According to one aspect of the present invention, the invention may provide a vehicle air-conditioning system including a heat exchanger to heat ventilating air by heat exchanging the ventilating air to an interior of a vehicle and a heat medium, a heater to heat the heat medium, and a pump to circulate the heat medium within a cycling loop to which the heat exchanger and the heater are connected, the system comprising: a first temperature detector for detecting temperature of the heat medium flowed in the heater; a second temperature detector for detecting temperature of the heat medium flowed out from the heater; and a fault identifying unit for identifying that the system is out of order when a preset first setting time elapses after a start of driving of the heater and the pump, a value obtained by subtracting temperature detected by the first temperature detector from temperature detected by the second temperature detector is less than or equal to a preset first threshold, and a value obtained by subtracting temperature detected by the second temperature detector before the start of the driving of the heater and the pump from temperature detected by the second temperature detector is less than or equal to a preset second threshold.

According to one aspect of the present invention, the fault identifying unit may identify that the fault identifying unit identifies that the system is out of order, in a case where a state satisfying conditions continues for a preset second setting time, the conditions being that the preset first setting time elapsed after the start of the driving of the heater and the pump, the value obtained by subtracting temperature detected by the first temperature detector from temperature detected by the second temperature detector is less than or equal to the preset first threshold, and the value obtained by subtracting temperature detected by the second temperature detector before the start of the driving of the heater and the pump from temperature detected by the second temperature detector is less than or equal to the preset second threshold.

### Advantageous Effect of the Invention

According to the present invention, since less influence of heat exchange rates of the heat exchanger is exerted on the temperature difference of the temperature detected by the first temperature detector, the second temperature detector, or the third temperature detector, before and after the start of the driving of the heater and the pump, the invention enables with high accuracy identification of the occurrence of system failure by using the temperature difference.

Furthermore, according to the present invention, since the system failure is identified based on a plurality of conditions, the invention enables to prevent inadvertent misidentification of system failure to achieve identification of the occurrence of system failure with high accuracy.

### BRIEF DESCRIPTION OF THE DRAWINGS

FIG. 1 is a view showing an exemplary construction of the vehicle air-conditioning system according to the present embodiment;

FIG. 2 is a flow chart showing one example of fault diagnosis process carried out by the controller;

FIG. 3 is a flow chart showing one example a procedure of driving control of the heater;

FIG. 4 is a flow chart showing one example of fault diagnosis process carried out by the controller in a variant of the present embodiment; and

FIG. 5 is a flow chart showing another example of fault diagnosis process carried out by the controller in a variant of the present embodiment.

### DESCRIPTION OF EMBODIMENTS

A description will be made to an exemplary construction of a vehicle air-conditioning system 10 installed in a vehicle 1.

Construction

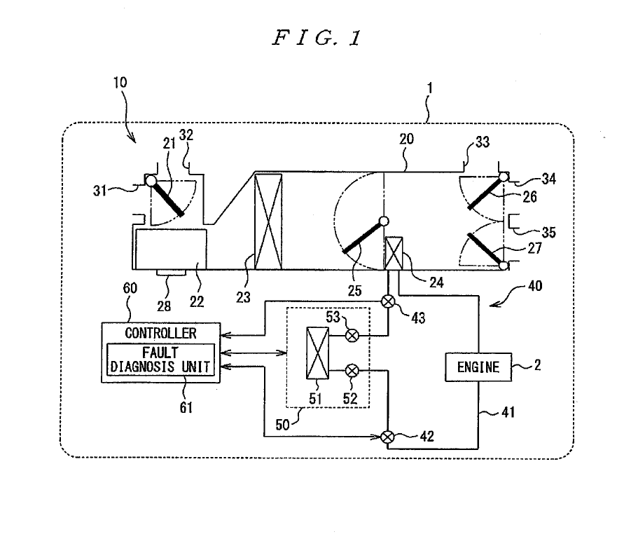

FIG. 1 is a view showing an exemplary construction of the vehicle air-conditioning system according to the present embodiment. Here, the vehicle 1 is a hybrid car.

As shown in FIG. 1, the vehicle air-conditioning system 10 includes an air-conditioning unit 20, a heat medium circulating unit 40, and a controller (e.g., an air-conditioning Electronic Control Unit (ECU)) 60.

As shown in FIG. 1, the air-conditioning unit 20 has a flow path formed for air-conditioning air. Depending on a contour of the flow path, a switching door 21, a blower fan (fan for air-conditioning) 22, an evaporator core 23, a heater core 24, an air mix door (A/M door) 25, and mode switching doors 26, 27 are disposed. In the air-conditioning unit 20, an outside air inlet 31, an inside air inlet 32, and blower outlets 33, 34, and 35 are provided, in correspondence with the switching door 21 and the mode switching doors 26, 27.

The switching door 21 opens and closes the outside air inlet 31 and the inside air inlet 32. The vehicle air-conditioning system 10 is configured to be possible to select, as an air induction mode, an inside air cycling mode to induct inside air, and an outside air induction mode to induct outside air. The switching door 21 opens and closes depending on a selected induction mode. Further, in the air-conditioning unit 20, the blower fan 22 is disposed between the outside air inlet 31 and the outside air outlet 32, and the evaporator core 23.

The blower fan 22 is rotary-driven by a blower fan motor 28. Thereby, air standing in the inside or the outside of a vehicle is inducted to the air-conditioning unit 20 and is then supplied to the evaporator core 23. As an alternative, driving stages of the blower fan 22 may be multiple (multiple stages).

The evaporator 23 performs heat exchange between refrigerant, which is changed into high temperature and high pressure to be liquefied by compressing the refrigerant using a compressor (not shown) and a condenser (not shown), and air passing through the evaporator core 23. Thereby, the air passing through the evaporator core 23 is cooled or dehumidified when passing through the evaporator core 23. Also, by selectively activating the compressor, air simply passes through the evaporator core 23 when the evaporator core 23 does not perform cooling or dehumidification. In the air-conditioning unit 20, the heater core 24 and the air mix door 25 are disposed at the downstream side of the evaporator core 23.

The heater core 24 heats air to be passed therethrough. The heater core 24 heats the air passing through the heater core 24 by circulating heat medium such as cooling water, etc., between the engine 2 and the heater core 24 by the heat medium circulating unit 40. Further, by selectively activating the heater core 24, air simply passes through the heater core 24 when the heater core 24 does not perform heating. As for an arrangement of the heat medium circulating unit 40, a detailed description will be made later.

In the air-conditioning unit 20, it is configured that air passed through the heater core 24 and air bypassed the heater core 24 are mixed therein, and that air quantity passed through the hater core 24 is controlled by a degree of opening of the air mix door 25. Thereby, the vehicle air-conditioning system 10 produces ventilation (air-conditioning air stream) having preset temperature. Then, in the air-conditioning unit 20, the produced ventilation is inducted to the blower outlets 33, 34, and 35.

The blower outlets 33, 34, and 35 include e.g., a defroster blower outlet opened toward front wind glass of a vehicle; a register blower outlet opened toward a passenger within a vehicle; and a front seat underfoot blower outlet opened toward a passenger's feet seated on a front seat. The blower outlets 33, 34, and 35 are selectively opened and closed by the mode switching doors 26, 27.

Moreover, the controllable driving unit such as the aforesaid switching door 21, the blower fan 22, the air mix door 25, and the mode switching doors 26, 27 are controlled by the controller 60.

In the heat medium circulating unit 40, an electric-powered water pump 42, an electric heater equipment 50, and a water temperature sensor 43 are disposed in a cycling loop 41 for circulating the cooling water. The engine 2 is in the cycling loop 41. The electric-powered water pump 42 circulates cooling water heated by the engine 2 in the cycling loop 41. At this moment, the cooling water which is supplied from the electric-powered water pump 42 passes through the electric heater equipment 50, then through the water temperature sensor 43, and is finally supplied to the heater core 24.

Here, the electric-powered water pump 42 is controlled by the controller 60. A value detected by the water temperature sensor 43 (temperature detected by the water temperature sensor) is input to the controller 60. The controller 60 controls driving of the electric-powered water pump 42 and the electric heater equipment 50 based on the detected value.

The electric heater equipment 50 includes a heater (e.g. PTC heater) 51 that is an auxiliary heater which heats the cooling water passing therethrough by electric energy; a heater inlet temperature sensor 52 which is disposed at an inlet of the heater 51, and detects temperature of the cooling water flowing into the heater 51; and a heater outlet temperature sensor 53 which is disposed at an outlet of the heater 51, and detects temperature of the cooling water flowing out from the heater 51.

The electric heater equipment 50 is controlled by the controller 60. For this reason, the controller 60 takes in a value detected by the heater inlet temperature sensor 52 (i.e., heater inlet sensor temperature), and a value detected by the heater outlet temperature sensor 53 (i.e., heater outlet sensor temperature), where the controller 60 controls driving of the heater 51 based on these detected values. That is, the controller 60 controls e.g., the driving of the heater such that the cooling water rises up to required temperature based on these detected values.

It goes without saying that the arrangement of the heat medium circulating unit 40 is for illustration purpose only, and so the electric-powered water pump 42, the electric heater equipment 50, and the water temperature sensor 43 are granted liberty to take an alternative without being necessarily limited to the arrangement, as mentioned above.

In the vehicle air-conditioning system 10 having such arrangement as above, fault diagnosis of the system is conducted and process is carried out depending on the results of the fault diagnosis. To this end, the controller 60 includes a fault diagnosis unit 61. The fault diagnosis unit 61 may e.g., be implemented by a device, or by a program.

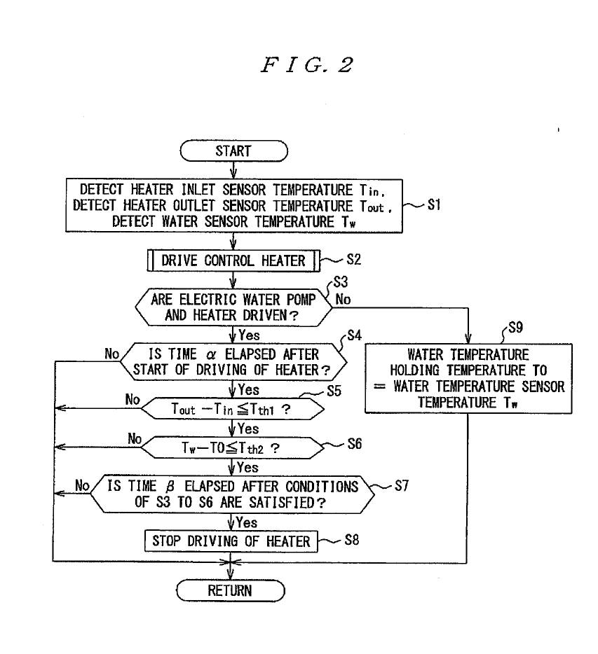

FIG. 2 is a flow chart showing one example of fault diagnosis process carried out by the controller 60.

As shown in FIG. 2, firstly, in step S1, the fault diagnosis unit 61 fetches a value detected by the heater inlet temperature sensor 52 (i.e., heater inlet sensor temperature Tᵢₙ), a value detected by the heater outlet temperature sensor 53 (i.e., heater outlet sensor temperature Tₒᵤₜ), and a value detected by the water temperature sensor 43 (i.e., water temperature sensor temperature T_{w}).

In subsequent step S2, the controller 60 (e.g., a driving control unit) controls the driving of the heater 51.

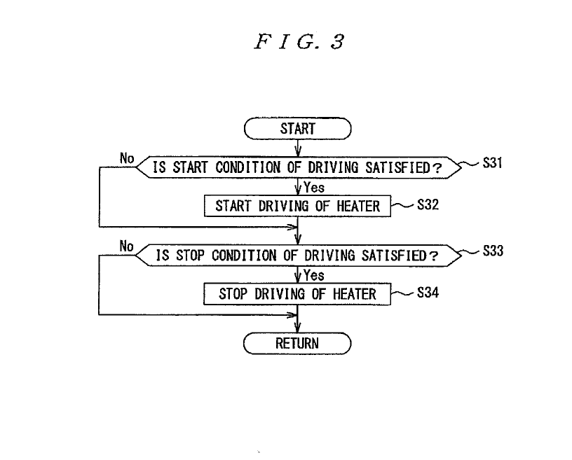

FIG. 3 is a flow chart showing one example of procedure of driving control of the heater 51.

As shown in FIG. 3, firstly, in step S31, the controller 60 determines whether a start condition of driving of the heater 51 is satisfied. For example, the controller 60 determines that the start condition of driving is satisfied when the water temperature sensor temperature T_{w} is less than or equal to preset temperature. The preset temperature here is temperature necessary to drive the heater 51, e.g., is temperature to be experimentally, empirically, or theoretically set.

The process of the controller 60 proceeds to step S32 if it is determined that the start condition of driving of the heater 51 is satisfied. Otherwise, the process of the controller 60 proceeds to step S33 if it is determined that the driving condition of the heater 51 is not satisfied.

In step S32, the controller 60 starts to drive the heater 51. Then the process of the controller 60 proceeds to step S33.

In step S33, the controller 60 determines whether a stop condition of driving of the heater 51 is satisfied. For example, the controller 60 determines that the stop condition of the driving is satisfied when the water temperature sensor temperature T_{w} is more than or equal to the preset temperature, or when a preset time of period elapses after the start of the driving of the heater 51. The preset temperature here is temperature unnecessary to drive the heater 51, e.g., is temperature to be experimentally, empirically, or theoretically set.

The process of the controller 60 proceeds to step S34 if it is determined that the stop condition of driving of the heater 51 is satisfied. Otherwise, the controller 60 then terminates process shown in FIG. 3 if it is determined that the stop condition of driving of the heater 51 is not satisfied.

In step 34, the controller 60 stops the driving of the heater 51. Thus, the controller 60 terminates the process shown in FIG. 3.

As is demonstrated, in step S2, the controller 60 performs driving control of the heater 51.

In succeeding step S3, the fault diagnosis unit 61 determines whether the electric-powered water pump 42 and the heater 51 are driven. More specifically, the fault diagnosis unit 61 identifies whether a driving control signal to drive the electric-powered water pump 42 and the heater 61 is output. The process of the fault diagnosis unit 61 proceeds to step S4, if it is determined that the electric-powered water pump 42 and the heater 51 are driven, i.e., the driving control signal is output. Otherwise, the process of the fault diagnosis unit 61 proceeds to step S9, if it is determined that the electric-powered water pump 42 and the heater 51 are not driven, i.e., the driving control signal is not output.

In step S9, the fault diagnosis unit 61 sets the water temperature sensor temperature T_{w} to water temperature holding temperature T0. Then, the fault diagnosis unit 61 terminates process shown in FIG. 2.

In step S4, the fault diagnosis unit 61 determines whether a preset driving continuation determination time a elapses after a start of driving of the heater 51. Here, the preset driving continuation determination time α is, e.g., a time until the detected value detected by the heater inlet sensor temperature 52 (i.e., heater inlet sensor temperature Tᵢₙ), the detected value detected by the heater outlet sensor temperature 53 (i.e., heater outlet sensor temperature Tₒᵤₜ), and the detected value detected by the water temperature sensor 43 (i.e., water sensor temperature T_{w}) indicate a steady value after the start of the driving of the heater 51. The time is set experimentally, empirically, or theoretically.

The process of the fault diagnosis unit 61 proceeds to step S5 if it is determined that the driving continuation determination time a elapses after the start of the driving of the heater 51. Otherwise, the fault diagnosis unit 61 terminates process shown in FIG. 2 if it is determined that the driving continuation determination time a does not elapse after the start of the driving of the heater 51.

In step S5, the fault diagnosis unit 61 determines whether a difference (Tₒᵤₜ−Tᵢₙ) between the heater outlet sensor temperature Tₒᵤₜ and the heater inlet sensor temperature Tᵢₙ is less than or equal to a preset first heating determination threshold Tₜₕ₁. Here, the preset first heating determination threshold Tₜₕ₁ is e.g., a value set experimentally, empirically, or theoretically. For example, a candidate of the preset first heating determination threshold Tₜₕ₁ may include 0 or its approximate value, but it need scarcely be said that it is not necessarily limited thereto.

If the fault diagnosis unit 61 determines that the difference between the heater sensor outlet temperature Tₒᵤₜ and the heater inlet sensor temperature Tᵢₙ is less than or equal to the first heating determination threshold Tₜₕ₁ (i.e., Tₒᵤₜ−Tᵢₙ≦Tₜₕ₁) the process proceeds to step S6. Otherwise, if the fault diagnosis unit 61 determines to be not so (i.e., Tₒᵤₜ−Tᵢₙ>Tₜₕ₁), the fault diagnosis unit 61 terminates process shown in FIG. 2.

In step S6, the fault diagnosis unit 61 determines whether the difference (T_{w}−T0) between the water temperature sensor temperature T_{w} and the water temperature holding temperature T0 set in step S9 is less than or equal to a preset second heating determination threshold Tₜₕ₂. Here, the difference is a difference between the water temperature sensor temperature T_{w} before a start of driving of the electric-powered water pump 42 and the heater 51, and the water temperature sensor temperature T_{w} after a start of driving (to be specific, after elapse of time a after a start of driving) of the electric-powered water pump 42 and the heater 51. Moreover, the second heating determination threshold Tₜₕ₂ is, e.g., a value set experimentally, empirically, or theoretically. For example, a candidate of the second heating determination threshold Tₜₕ₂ includes 0 or its approximate value, but it need scarcely be said that the threshold is not necessarily limited thereto.

If the fault diagnosis unit 61 determined that the difference between the water temperature sensor temperature T_{w} and the water temperature holding temperature T0 is less than or equal to the second heating determination threshold Tₜₕ₂ (i.e., T_{w}−T0≦Tₜₕ₂), the process proceeds to step S7. Otherwise, if the fault diagnosis unit 61 determines to be not so (i.e., T_{w}−T0>Tₜₕ₂), the fault diagnosis unit 61 terminates process shown in FIG. 2.

In step S7, the fault diagnosis unit 61 determines whether the satisfied state continues and a preset satisfied state continuation determination time β elapses, after all determination conditions insteps S3 to S6 are satisfied (i.e., all determination results are “Yes”). In other words, the fault diagnosis unit 61 determines whether a state where all determination conditions in steps S3 to S6 continues during the preset satisfied state continuation determination time β. Here, the satisfied state continuation determination time β is, e.g., a time set experimentally, empirically, or theoretically.

If the fault diagnosis unit 61 determines that all determination conditions in steps S3 to S6 are satisfied, its satisfied state continues, and the preset satisfied state continuation determination time β elapses, the process proceeds to step S8. Otherwise, if the fault diagnosis unit 61 determines not to be so, the fault diagnosis unit 61 terminates process shown in FIG. 2.

In step S8, the controller 60 (e.g., driving control unit) stops the driving of the heater 51. That is to say, the controller 60 stops outputting the driving control signal to the heater 51.

Operation, etc.,

An explanation will then be made to one example of the vehicle air-conditioning system 10 implemented by process shown in FIG. 2 as above.

The vehicle air-conditioning system 10 detects the heater inlet sensor temperature Tᵢₙ, the heater outlet sensor temperature Tₒᵤₜ, and the water temperature sensor temperature T_{w}, as well as drives the heater 51 depending on a start condition of driving and/or a stop condition of driving, etc (step S1 and step S2).

At this moment, the vehicle air-conditioning system 10 sets the water temperature sensor temperature Tw to the water temperature holding temperature T0 until the start of the driving of the electric-powered water pump 42 and the heater 51 is started (step S3 and step S9).

Then, when the driving of the electric-powered water pump 42 and the heater 51 is started (i.e., when the driving control signal is output), the vehicle air-conditioning system 10 performs process according to the driving continuation determination time α, the satisfied state continuation determination time β, the heater inlet sensor temperature Tᵢₙ, the heater outlet sensor temperature Tₒᵤₜ, and the water temperature sensor temperature t_{w} (step S3 to step S8).

Namely, the vehicle air-conditioning system 10 identified that the system is out of order and terminates the driving of the heater 51 when the driving continuation determination time α elapses after the start of the driving of the heater 51, a difference between the heater outlet sensor temperature Tₒᵤₜ and the heart inlet sensor temperature Tᵢₙ is less than or equal to the first heating determination threshold Tₜₕ₁, a difference between the water temperature sensor temperature T_{w} and the water temperature holding temperature T0 is less than or equal to the second heating determination threshold Tₜₕ₂, and these all conditions are satisfied and the satisfied state continuation determination time β elapses. At this moment, the vehicle air-conditioning system 10 may stop the electric-powered water pump 42, as needed.

The system failure here includes a situation where the electric-powered water pump 42 and/or the heater 51 are not operational, or a situation where cooling water is in short supply, etc.

In the present embodiment, the heater core 24, e.g., constitutes the heat exchanger unit. Further, the heater 51, e.g., constitutes the heater unit. Furthermore, the heater inlet temperature sensor 52, e.g., constitutes the first temperature detector. Moreover, the heater outlet temperature sensor 53, e.g., constitutes the second temperature detector. Moreover, the water temperature sensor 43, e.g., constitutes the third temperature detector. Besides, the fault diagnosis unit 61, e.g., constitutes the fault identification unit.

### Effects of the Present Embodiment

The effects of the present embodiment are as follows.

Since less influence of heat exchange rates of the heater core 24 is exerted on a temperature difference between the water temperature sensor temperature T_{w} before the start of the driving of the electric-powered water pump 42 and the heater 51 and the water temperature sensor temperature T after the start of the driving of the electric-powered water pump 42 and the heater 51, the vehicle air-conditioning system 10 is capable of identifying with high accuracy the occurrence of system failure by using the temperature difference.

That is, depending on conditions, such as air quantity of the blower fan 22, driving stages of the blower fan 22, a degree of opening of the air mix door 25, exterior air temperature, and blower outlet temperature, etc., the heat exchange rates of the heater core 24 are small. Accordingly, there may be a case where the temperature difference between the heater outlet sensor temperature Tₒᵤₜ and the heater inlet sensor temperature Tᵢₙ is small. In this situation, if system failure identification is made by mistake only by relying upon the temperature difference, erroneous identification of system failure could occur. Meanwhile, where heat exchange rates of the heater core 24 are small, it follows that temperature of the heat medium rises after the driving of the electric-powered water pump 42 and the heater 51 is started, and the water temperature sensor temperature T_{w} will rise as a consequence.

From these facts, it is conceivable that less influence of the heat exchange rates of the heater core 24 is exerted on the temperature difference between the water temperature sensor temperature T_{w} before the start of the driving of the electric-powered water pump 42 and the heater 51 and the water temperature sensor temperature T_{w} after the driving of the electric-powered water pump 42 and the heater 51. Thus, the vehicle air-conditioning system 10 of the present embodiment may identify the occurrence of system failure with high accuracy by using the temperature difference.

In addition, since the vehicle air-conditioning system 10 identifies the occurrence of system failure based on multiple conditions (i.e., conditions in step S4 to step S7), the vehicle air-conditioning system 10 prevents inadvertent misidentification of the system failure, thereby enabling with high accuracy identification of the occurrence of system failure.

### MODIFICATION TO THE PRESENT EMBODIMENT

A modification of the present embodiment is as follows.

The present embodiment is not necessarily limited to a configuration where process in step S5 is carried out based on the water temperature sensor temperature T_{w}. Put differently, in the present embodiment, the process in step S5 can also be performed based on the heater inlet sensor temperature Tᵢₙ or the heater outlet sensor temperature Tₒᵤₜ.

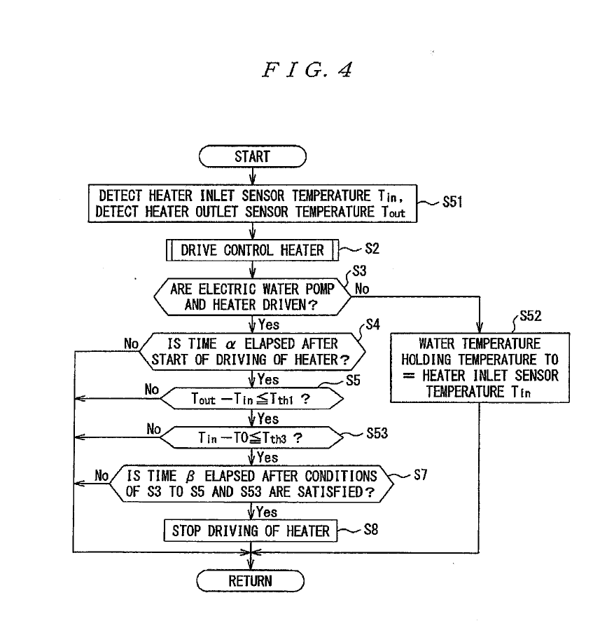

FIG. 4 is a flow chart showing an exemplary process in a case where the process is performed based on the heater inlet sensor temperature Tᵢₙ.

In this case, as shown in FIG. 4, firstly in step S51, the fault diagnosis unit 61 fetches the value detected by the heater inlet temperature sensor 52 (i.e., heater inlet sensor temperature Tᵢₙ), and the value detected by the heater outlet temperature sensor 53 (i.e., heater outlet temperature Tₒᵤₜ).

Then, in step S52 to which the process proceeds if it is determined in step S3 that the electric-powered water pump 42 and the heater 51 are not driven, the fault diagnosis unit 61 sets the heater inlet sensor temperature Tᵢₙ to the water temperature holding temperature T0.

Thereby, in step S53 to which the process proceeds if it is determined in step S5 that a difference between the heater outlet sensor temperature Tₒᵤₜ and the heater inlet sensor temperature Tᵢₙ (i.e., Tₒᵤₜ−Tᵢₙ) is less than or equal to the first heating determination threshold Tₜₕ₁, the fault diagnosis unit 61 determines whether a difference between the heater inlet sensor temperature Tᵢₙ and the water temperature holding temperature T0 set in step S52 (i.e., Tᵢₙ−T0) is less than or equal to a preset third heating determination threshold Tₜₕ₃. Here, the difference is a difference between the heater inlet sensor temperature Tᵢₙ before the start of the driving of the electric-powered water pump 42 and the heater 51 and the heater inlet sensor temperature Tᵢₙ after the start of the driving of the electric water pump 42 and the heater 51 (to be specific, after elapse of time a after a start of driving). Further, the third heating determination threshold Tₜₕ₃ is a value set, e.g., experimentally, empirically, or theoretically. For example, a candidate of the third heating determination threshold Tₜₕ₃ includes 0 or its approximate value, but it need scarcely be said that the threshold is not necessarily limited thereto.

If the fault diagnosis unit 61 determines that a difference between the heater inlet sensor temperature Tᵢₙ and the water temperature holding temperature T0 is less than or equal to the third heating determination threshold Tₜₕ₃ (i.e., Tᵢₙ−T0≦Tₜₕ₃) the process proceeds to step S7. Otherwise, if the fault diagnosis unit 61 determined not to be so (Tᵢₙ−T0>Tₜₕ₃), the fault diagnosis unit 61 terminates process shown in FIG. 4.

With the process as above, in the modification to the present embodiment, as with the effects of the aforesaid embodiment, since less influence of heat exchange rates of the heater core 24 is exerted on the temperature difference between the heater inlet sensor temperature Tᵢₙ, before and after the start of the driving of the electric water pump 42 and the heater 51, the modification enables with high accuracy identification of the occurrence of system failure by using the temperature difference.

In the modification of the present embodiment, because multiple conditions are used to identify the occurrence of system failure, the modification prevents inadvertent misidentification of the system failure, thereby enabling with high accuracy identification of the occurrence of system failure.

Moreover, in the modification of the present embodiment, different from the aforementioned embodiment, as it does not need to be provided with the water temperature sensor 43, the modification allows identification of the occurrence of system failure while suppressing an increase in the number of the temperature sensor, or identification of the occurrence of system failure even in a vehicle not equipped with the water temperature sensor 43.

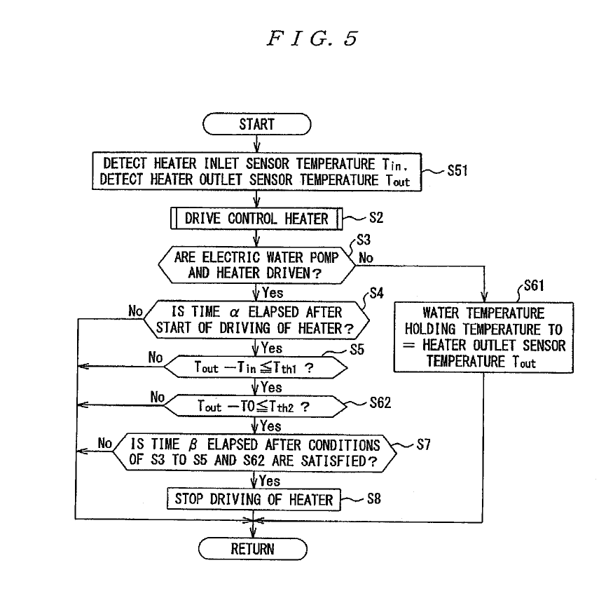

FIG. 5 is a flow chart showing an exemplary process in a case where the process is carried out based on the heater outlet sensor temperature Tₒᵤₜ.

In this case, as shown in FIG. 5, firstly in step S51, the fault diagnosis unit 61 fetches the value detected by the heater inlet temperature sensor 52 (i.e., heater inlet sensor temperature Tᵢₙ), and the value detected by the heater outlet temperature sensor 53 (i.e., heater outlet sensor temperature Tₒᵤₜ). Then, in step S61 to which the process proceeds if it is determined in step S3 that the electric-powered water pump 42 and the heater 51 are not driven, the fault diagnosis unit 61 sets the heater outlet sensor temperature Tₒᵤₜ to the water temperature holding temperature T0.

Thereby, in step S62 to which the process proceeds if it is determined in step S5 that a difference between the heater outlet sensor temperature Tₒᵤₜ and the heater inlet sensor temperature Tᵢₙ is less than or equal to the first heating determination threshold Tₜₕ₁, the fault diagnosis unit 61 determines whether a difference between the heater outlet sensor temperature Tₒᵤₜ and the water temperature holding temperature T0 set in step S61, (i.e., Tₒᵤₜ−T0), is less than or equal to the preset fourth heating determination threshold Tₜₕ₄. Here, the difference is a difference between the heater outlet sensor temperature Tₒᵤₜ before the start of the driving of the electric-powered water pump 42 and the heater 51 and heater outlet sensor temperature Tₒᵤₜ after the start of the driving of the electric-powered water pump 42 and the heater 51 (to be specific, after elapse of time a after a start of driving). Also, the fourth heating determination threshold Tₜₕ₄ is a value set, e.g., experimentally, empirically, or theoretically. For example, a candidate of the fourth heating determination threshold Tₕₜ₄ includes 0 or its approximate value, but it need scarcely be said that the threshold is not necessarily limited thereto.

If the fault diagnosis unit 61 determines that a difference between the heater outlet sensor temperature Tₒᵤₜ and the water temperature holding temperature T0 is less than or equal to the fourth heating determination threshold Tₜₕ₄ (i.e., Tₒᵤₜ−T0≦Tₜₕ₄), the process proceeds to step S7. Otherwise, if the fault diagnosis unit 61 determines not to be so (i.e., Tₒᵤₜ−T0>Tₜₕ₄), the fault diagnosis unit 61 terminates process shown in FIG. 5.

With the process as above, in the modification of the present embodiment, as with the effects of the aforesaid embodiment, because less influence of heat exchange rates of the heater core 24 is exerted on the temperature difference between the heater outlet sensor temperature Tₒᵤₜ before the start of the driving of the electric-powered water pump 42 and the heater 51 and the heater outlet sensor temperature Tₒᵤₜ after the start of the driving of the electric-powered water pump 42 and the heater 51, the modification enables identification with high accuracy the occurrence of system failure by using the temperature difference.

In the modification of the present embodiment, multiple conditions are used to identify the occurrence of system failure, thus, the modification prevents inadvertent misidentification of the system failure, thereby enabling with high accuracy identification of the occurrence of system failure.

Further, in the modification of the present embodiment, different from the aforesaid embodiment, because it does not need to be provided with the water temperature sensor 43, the modification allows identification of the occurrence of system failure while suppressing an increase in the number of the temperature sensor.

In the modification of the present embodiment, regardless of the determination results in step S7, the driving of the heater 51 may be stopped. In other words, in the modification of the present embodiment, as long as all determination conditions (step S3 to step S6, step S3 to step S5 and step S53, or step S3 to step S5 and step S62) are satisfied (even when (β=0), the driving of the heater 51 may be stopped.

Thereby, the vehicle air-conditioning system 10 early identifies the occurrence of system failure, and is allowed to stop the driving of the heater 51.

Further, in the modification of the present embodiment, an additional condition identifying that the engine is stopped may be added to the determination conditions of step S3 to S7 (or step S3 to step S6). In other words, in the modification of the present embodiment, if it is identified that the engine is stopped, the driving of the heater 51 may be stopped.

Thereby, because the vehicle air-conditioning system 10 identifies the occurrence of system failure, with less influence upon temperature detected by a sensor, due to heating of the cooling water by the engine, the embodiment allows with high accuracy identification of the occurrence of system failure.

In the modification of the present embodiment, the first, the second, the third, and the fourth heating determination thresholds Tₜₕ₁, Tₜₕ₂, Tₜₕ₃, and Tₜₕ₄ may be set based on factors affecting the heat exchange rates of the heater core 24. That is, for example, in the modification of the present embodiment, the first, the second, the third, and the fourth heating determination thresholds Tₜₕ₁, Tₜₕ₂, Tₜₕ₃, and Tₜₕ₄ may be set based on air quantity of the blower fan 22, driving stages of the blower fan 22, a degree of opening of the air mix door 25, exterior air temperature, or diffuser temperature, etc.

Thereby, in the modification of the present embodiment, since the first, the second, the third, and the fourth heating determination thresholds Tₜₕ₁, Tₜₕ₂, Tₜₕ₃, and Tₜₕ₄ may be set, taking a change in the heart exchange rates into account, the modification allows with high accuracy identification of the occurrence of system failure, even if the heat exchange rates are changed.

Further, in the modification of the present embodiment, fluid other than water may be employed as heat medium.

In the modification of the present embodiment, the vehicle may be an electric vehicle not equipped with an engine.

### REFERENCE SIGNS LIST

10: vehicle air-conditioning system
24: heater core
42: electric-powered water pump
43: water temperature sensor
51: heater
52: heater inlet temperature sensor
53: heart outlet temperature sensor
61: fault diagnosis unit

1. A vehicle air-conditioning system including a heat exchanger to heat ventilating air by heat-exchanging the ventilating air to an interior of a vehicle and a heat medium, a heater to heat the heat medium, and a pump to circulate the heat medium within a cycling loop to which the heat exchanger and the heater are connected, the system comprising:
a first temperature detector for detecting temperature of the heat medium flowed in the heater;
a second temperature detector for detecting temperature of the heat medium flowed out from the heater;
a third temperature detector installed in the cycling loop for detecting temperature of the heat medium in the cycling loop;
and
a fault identifying unit for identifying that the system is out of order when a preset first setting time elapses after a start of driving of the heater and the pump, a value obtained by subtracting temperature detected by the first temperature detector from temperature detected by the second temperature detector is less than or equal to a preset first threshold, and a value obtained by subtracting temperature detected by the third temperature detector before the start of the driving of the heater and the pump from temperature detected by the third temperature detector is less than or equal to a preset second threshold.

2. The vehicle air-conditioning system according to claim 1, wherein the fault identifying unit identifies that the system is out of order, in a case where a state satisfying conditions continues for a preset second setting time, the conditions being that the preset first setting time elapsed after the start of the driving of the heater and the pump, the value obtained by subtracting temperature detected by the first temperature detector from temperature detected by the second temperature detector is less than or equal to the preset first threshold, and the value obtained by subtracting temperature detected by the third temperature detector before the start of the driving of the heater and the pump from temperature detected by the third temperature detector is less than or equal to the preset second threshold.

3. A vehicle air-conditioning system including a heat exchanger to heat ventilating air by heat-exchanging the ventilating air to an interior of a vehicle and a heat medium, a heater to heat the heat medium, and a pump to circulate the heat medium within a cycling loop to which the heat exchanger and the heater are connected, the system comprising:
a first temperature detector for detecting temperature of the heat medium flowed in the heater;
a second temperature detector for detecting temperature of the heat medium flowed out from the heater;
and
a fault identifying unit for identifying that the system is out of order when a preset first setting time elapses after a start of driving of the heater and the pump, a value obtained by subtracting temperature detected by the first temperature detector from temperature detected by the second temperature detector is less than or equal to a preset first threshold, and a value obtained by subtracting temperature detected by the first temperature detector before the start of the driving of the heater and the pump from temperature detected by the first temperature detector is less than or equal to a preset second threshold.

4. The vehicle air-conditioning system according to claim 3, wherein the fault identifying unit identifies that the system is out of order, in a case where a state satisfying conditions continues for a preset second setting time, the conditions being that the preset first setting time elapsed after the start of the driving of the heater and the pump, the value obtained by subtracting temperature detected by the first temperature detector from temperature detected by the second temperature detector is less than or equal to the preset first threshold, and the value obtained by subtracting temperature detected by the first temperature detector before the start of the driving of the heater and the pump from temperature detected by the first temperature detector is less than or equal to the preset second threshold.

5. A vehicle air-conditioning system including a heat exchanger to heat ventilating air by heat exchanging the ventilating air to an interior of a vehicle and a heat medium, a heater to heat the heat medium, and a pump to circulate the heat medium within a cycling loop to which the heat exchanger and the heater are connected, the system comprising:
a first temperature detector for detecting temperature of the heat medium flowed in the heater;
a second temperature detector for detecting temperature of the heat medium flowed out from the heater;
and
a fault identifying unit for identifying that the system is out of order when a preset first setting time elapses after a start of driving of the heater and the pump, a value obtained by subtracting temperature detected by the first temperature detector from temperature detected by the second temperature detector is less than or equal to a preset first threshold, and a value obtained by subtracting temperature detected by the second temperature detector before the start of the driving of the heater and the pump from temperature detected by the second temperature detector is less than or equal to a preset second threshold.

6. The vehicle air-conditioning system according to claim 5, wherein the fault identifying unit identifies that the system is out of order, in a case where a state satisfying conditions continues for a preset second setting time, the conditions being that the preset first setting time elapsed after the start of the driving of the heater and the pump, the value obtained by subtracting temperature detected by the first temperature detector from temperature detected by the second temperature detector is less than or equal to the preset first threshold, and the value obtained by subtracting temperature detected by the second temperature detector before the start of the driving of the heater and the pump from temperature detected by the second temperature detector is less than or equal to the preset second threshold.
